(19) United States
(12) Patent Application Publication
(10) Pub. No.: US 2008/0029919 A1
(43) Pub. Date: Feb. 7, 2008

(54) Method for Permanently Obturating Holes, Especially in Metal Sheets of Plastic Part of an Automobile

(75) Inventors: Bernd Howe, Hamburg (DE); Frank Kolmorgen, Hamburg (DE); Patrick Gehringer, Bois le Roi (FR)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 10/599,731

(22) PCT Filed: Mar. 11, 2005
(86) PCT No.: PCT/EP05/51101

§ 371 Date: Nov. 13, 2006

(30) Foreign Application Priority Data
Apr. 8, 2004 (DE) 10 2004 018047.4

(51) Int. Cl. B23P 6/00

(52) U.S. Cl. 264/46.5

(57) ABSTRACT

The invention relates to a method for permanently obturating holes, especially in metal sheets or plastic parts of automobile bodies. The inventive method is characterized by using a punched article which is at least partially provided on one side with an adhesive material and includes an especially textile support whose surface is greater than the surface of the hole to be obturated and which is especially provided with a non-expanded expandable body in the center of the adhesive side. The punched article is fixed on the hole together with the support in such a manner that the hole is completely covered by the punched article and the expandable body comes to rest inside the hole. The punched article and the expandable body are heated to such an extent that the expandable body expands, heat is supplied until the expanded expandable body completely fills and/or covers the hole, and the expanded expandable body cools off and cures.

The present invention relates to a method for permanently obturating holes, especially in metal sheets or plastic parts of automobile bodies.

In the course of the production of modern automobiles it is inevitable that during assembly holes of various sizes will come about as a consequence of the construction system in numerous individual parts such as metal sheets or plastic parts. The diameters of the holes are typically between 10 and 50 mm. In subsequent operation, many of these holes must be obturated in such a way that they are airtight and, in particular, watertight, in order to prevent corrosive attack by water or water vapor penetrating through the non-covered holes into the bodywork. An accompanying requirement is that of obturating the holes to achieve a considerable improvement in the suppression of noise in the passenger compartment.

At the present time, bodywork holes are generally obturated using plastic stoppers, which on the one hand do not reliably obturate the hole in certain cases and on the other hand are comparatively complicated and expensive to produce.

Each size of hole requires a specific stopper adapted to the size of hole. This involves high logistical and administration complexity and cost for the purchaser of the stoppers.

On the production line, consequently, a large number of stoppers in different sizes, each in allocated storage compartments, have to be provided.

Additionally suitable for this purpose are adhesive tapes, which are punched or separated into lengths to fit to the size of hole. Even adhesive tapes, however, do not always come up to the increasing requirements in the market.

It is an object of the present invention to provide a method suitable for permanently obturating holes, especially in metal sheets or plastic parts of automobile bodies. A further intention is to ensure that said holes are obturated in such a way that the passage of moisture is excluded, the noise suppression is improved and the holes are reliably obturated even in the event of stone chipping on the underbody and/or in the event of mechanical stresses in the interior, particularly in the floor area.

This object is achieved by means of a method as set down in the main claim. The sub-claims provide advantageous developments of the subject matter of the invention.

The invention accordingly provides a method for permanently obturating holes, especially in metal sheets or plastic parts of automobile bodies, by
fixing an at least partly single-sidedly self-adhesively treated diecut having a backing, in particular a textile backing, whose area is greater than the area of the hole to be obturated and which is provided, in particular centrally, on the adhesively treated side with a non-foamingly expanded foam body, said fixing being carried out on the hole in such a way that the hole is completely covered by the diecut and the foam body is located within the hole,
heating the diecut with the foam body in such a way that the foam body foamingly expands,
the supply of heat being continued until the foamingly expanded foam body completely fills and/or covers the hole,
the foamingly expanded foam body cooling and hardening.

In one advantageous embodiment the diecut is provided with adhesive over its full area beneath the foam body.

With further preference the unfoamed foam body is composed of polyurethane or, with particular preference, of an EVA foam and/or has a thickness 1.5 to 4 mm.

The vinyl acetate content of the EVA is advantageously approximately 5% to 20% by weight. The EVA is extruded to a matrix and already includes a blowing agent before the operation of diecutting into the shape of the foam body takes place.

A typical size for the unfoamed foam body, which can be used to obturate many of the smaller holes, is that of a disk having a diameter of 10 to 30 mm, in particular 10 mm, and, moreover, having a thickness of 3 mm.

A further advantageous development of the invention the backing of the diecut is provided with an adhesive coating of natural rubber and/or a PVC coating or acrylic coating on the side opposite from the adhesive.

With further preference the bond strength to steel is at least 5 N/25 mm.

The backing, which in one advantageous development of the invention is composed of an aluminum foil, a textile backing or a polymeric film (for example, PVC, PP, PET, PU), preferably has a thickness
between 30 and 120 μm for the aluminum foil,
between 180 and 300 μm for a textile backing, and
between 30 and 300 μm for a film.

Backing material used for the diecut in one particularly advantageous continuation of the invention comprises woven cotton fabric having in particular a mesh count of 140 to 160, preferably 148 (implying a warp thread count of 74 and a weft thread count of 74).

With further preference the weft count is 70 to 80 and/or the warp count is 70 to 80.

As backing material for the diecut it is possible to use all known textile backings, such as wovens, knits or nonwoven webs; the term “non woven web” embraces at least textile sheetlike structures in accordance with EN 29092 (1988) and also stitchbonded nonwovens and similar systems.

It is likewise possible to use spacer fabrics, including wovens and knits, with lamination.

Spacer fabrics of this kind are disclosed in EP 0 071 212 B1. Spacer fabrics are matlike layer structures comprising a cover layer of a fiber or filament web, an underlayer and individual retaining fibers or bundles of such fibers between these layers, said fibers being distributed over the area of the layer structure, being needled through the particle layer, and joining the cover layer and the underlayer to one another. As an additional, though not mandatory, feature, the retaining fibers in accordance with EP 0 071 212 B1 comprise inert mineral particles, such as sand, gravel or the like, for example.

The holding fibers needled through the particle layer hold the cover layer and the underlayer at a distance from one another and are joined to the cover layer and the underlayer.

Spacer wovens or spacer knits are described, inter alia, in two articles, namely
an article from the journal kettenwirk-praxis 3/93, pages 59 to 63, “Raschelgewirkte Abstandsgewirke” [Raschel-knitted spacer knits]
   and
an article from the journal kettenwirk-praxis 1/94, pages 73 to 76, “Raschelgewirkte Abstandsgewirke”,
   the content of said articles being included here by reference and being part of this disclosure and invention.

Suitable nonwovens include, in particular, consolidated staple fiber webs, but also filament webs, meltblown webs, and spunbonded webs, which generally require additional consolidation. Possible consolidation methods for webs are mechanical, thermal, and chemical consolidation. Whereas with mechanical consolidations the fibers are held together purely mechanically, usually by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to fiber nodal points, so that a stable, three-dimensional network is formed while retaining the loose, open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Mayer, formerly Malimo, and can be obtained, inter alia, from the companies Naue Fasertechnik and Techtex GmbH. A Malifleece is characterized in that a cross-laid web is consolidated by the formation of loops from fibers of the web.

The backing used may also be a web of the Kunit or Multiknit type. A Kunit web is characterized in that it originates from the processing of a longitudinally oriented fiber web to form a sheetlike structure which has loops on one side and, on the other, loop feet or pile fiber folds, but possesses neither threads nor prefabricated sheetlike structures. A web of this kind has been produced, inter alia, for many years, for example on stitchbonding machines of the “Kunitvlies” type from the company Karl Mayer. A further characterizing feature of this web is that, as a longitudinal-fiber web, it is able to absorb high tensile forces in the longitudinal direction. The characteristic feature of a Multiknit web relative to the Kunit is that the web is consolidated on both the top and bottom sides by virtue of double-sided needle punching.

Finally, stitchbonded webs are also suitable as an intermediate for forming a diecut to be used according to the invention. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

Starting materials envisaged for the textile backing include, in particular, polyester, polypropylene, viscose, staple rayon or cotton fibers. The present invention is, however, not restricted to said materials; rather it is possible to use a large number of other fibers to produce the web, as is evident to the skilled worker without any need for inventive activity.

Particularly advantageous for the concept of the invention is a nonfogging diecut, comprising a nonfogging backing applied to at least one side of which is a nonfogging, pressure-sensitive adhesive.

As adhesives it is possible in principle to choose a variety of polymer systems, with natural-rubber or synthetic-rubber and also acrylate systems having proven particularly advantageous if their adhesive properties and temperature stabilities are in accordance with the requirements.

A suitable adhesive is one based on acrylate hotmelt which has a K value of at least 20, in particular more than 30 (measured in each case in 1% strength by weight solution in toluene, 25° C.), obtainable by concentrating a solution of such an adhesive to give a system which can be processed as a hotmelt.

Concentration may take place in appropriately equipped tanks or extruders; particularly in the case of accompanying devolatilization, a devolatilizing extruder is preferred.

An adhesive of this kind is set out in German patent application DE 43 13 008 C2. In an intermediate step, the solvent is removed completely from the acrylate compositions prepared in this way.

The K value here is determined in particular in analogy to DIN 53 726.

Additionally it is possible to use a hotmelt adhesive composed from the group of the natural rubbers or synthetic rubbers or composed of any desired blend of natural rubbers and/or synthetic rubbers, it being possible to select the natural rubber or the natural rubbers in principle from all available grades, such as, for example, crepe, RSS, ADS, TSR or CV grades, depending on the required purity and viscosity level, and to select the synthetic rubber or synthetic rubbers from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate (EVA) copolymers and polyurethanes and/or blends thereof.

With further preference it is possible to add thermoplastic elastomers to the rubbers, in order to improve the processing properties, with a weight fraction of from 10% to 50% by weight, based on the total elastomer fraction.

As representatives mention may be made at this point in particular of the especially compatible styrene-isoprene-styrene (SIS) and styrene-butadiene-styrene (SBS) products.

Tackifying resins which can be used include without exception all tackifier resins which are already known and have been described in the literature. As representatives mention may be made of the rosins, their disproportionated, hydrogenated, polymerized, and esterified derivatives and salts, the aliphatic and aromatic hydrocarbon resins, terpene resins and terpene-phenolic resins. Any desired combinations of these and further resins may be used in order to adjust the properties of the resultant adhesive in accordance with requirements. Express reference may be made to the depiction of the state of the art in the “Handbook of Pressure Sensitive Adhesive Technology” by Donatas Satas (van Nostrand, 1989).

Preferably the foaming expansion of the diecut by supply of heat takes place during the conventional coating operation on the body shell, in particular during the drying after coating or after cathodic electrodeposition. In this way no additional operation is needed.

Owing to the required heating of the body during said drying operations, sufficient energy is present to cause foaming expansion of the foam bodies.

An alternative option is to carry out foaming expansion by local supply of energy, by means of radiant heaters or infrared lamps.

Particularly in the case of heightened mechanical stress, the method of the invention is superior to the solutions known from the prior art. The same applies in consideration of noise suppression. Noise suppression and strength are massively improved through the combination of an adhesive diecut with a foam.

In addition it is possible for a single embodiment of the diecut to cover a multiplicity of different-sized holes.

Below, with reference to two figures, the method for permanently obturating holes, especially in metal sheets or plastic parts of automobile bodies, will be illustrated in greater detail, without any intention that this should in any way have a restrictive effect.

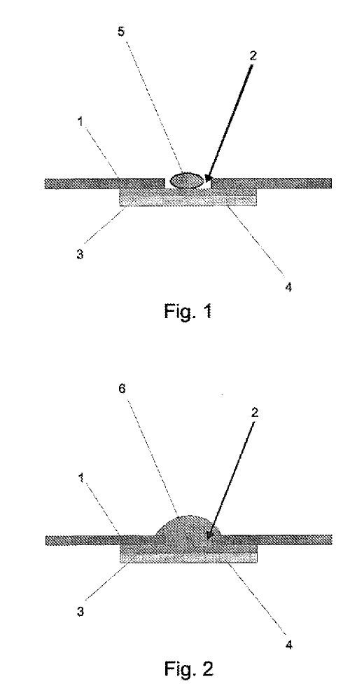

FIG. 1 shows the state before the hole to be obturated is encapsulated by exposure to heat, and

FIG. 2 shows the state after the hole has been obturated by foaming expansion of the diecut.

In the body 1, as a result of the construction system, there is a hole 2 requiring obturation.

For this purpose a partly, single-sidedly self-adhesively treated diecut having a textile backing 4 whose area is greater than the area of the hole 2 to be obturated is fixed to the hole 2 in such a way that the hole 2 is completely covered by the diecut.

Located centrally on the diecut, and on the adhesively treated side, is the non-foamingly expanded EVA foam body 5. This EVA foam body 5 is arranged centrally within the hole 2.

On the diecut the adhesive 3 is applied over the full area—even the region beneath the EVA foam body 5 is coated.

As a result of the heating of the EVA foam body 5 to preferably 160° C., the foam body 5 foams expandingly, leading to a considerable three-dimensional expansion thereof. The foaming expansion of the EVA foam body 5 by supply of heat takes place during the conventional coating operation on after the body shell, in particular during the drying coating or after cathodic electrodeposition. In the course of this operation the EVA foam body 5 expands foamingly, so that the hole 2 is completely filled, and therefore covered, by the foamingly expanded EVA foam body 6. After cooling, the foamingly expanded EVA foam body 6 hardens and thereby closes the hole 2 in an airtight, watertight and also noise-suppressing manner.

FIG. 2 shows the state after heat has been caused to act on the diecut.

1. A method for permanently obturating holes, especially in metal sheets or plastic parts of automobile bodies, by
fixing an at least partly single-sidedly self-adhesively treated diecut having a backing, in particular a textile backing, whose area is greater than the area of the hole to be obturated and which is provided, in particular centrally, on the adhesively treated side with a non-foamingly expanded foam body, said fixing being carried out on the hole in such a way that the hole is completely covered by the diecut and the foam body is located within the hole,
heating the diecut with the foam body in such a way that the foam body foamingly expands,
the supply of heat being continued until the foamingly expanded foam body completely fills and/or covers the hole,
cooling and hardening the foamingly expanded foam body.

2. The method of claim 1, wherein the diecut is provided with adhesive over its full area beneath the foam body.

3. The method of claim 1, wherein the unfoamed foam body is composed of polyurethane or, EVA foam and/or has a thickness of 1.5 to 4 mm.

4. The method of claim 1, wherein the diecut has an adhesive coating of natural rubber and/or a PVC coating or acrylic coating on the side opposite from the adhesive.

5. The method of claim 1, wherein backing material used for the diecut comprises woven cotton fabric having a weft count of 70 to 80 and/or a warp count of 70 to 80.

6. The method of claim 1, wherein the foaming expansion of the diecut by supply of heat takes place during the during the drying of the body shell after coating or after cathodic electrodeposition.
